(19) United States
(12) Patent Application Publication
(10) Pub. No.: US 2003/0232896 A1
(43) Pub. Date: Dec. 18, 2003

(54) Remoistenable pre-applied foamed adhesive

(76) Inventors: John W. Muren, Westerville, OH (US); David W. Lydzinski, Belle Mead, NJ (US); Christopher Scott Thomas, Plainfiled, NJ (US)

Correspondence Address: Cynthia L. Foulke, NATIONAL STARCH AND CHEMICAL COMPANY, 10 Finderne Avenue, Bridgewater, NJ, 08807-0500, US

(21) Appl. No.: 10/173,300

(22) Filed: Jun. 17, 2002

(51) Int. Cl. B32B 7/12; B32B 15/04

(52) U.S. Cl. 521/141; 521/142

(57) ABSTRACT

A pre-applied, remoistenable foamed adhesive useful in bonding substrates together.

### FIELD OF THE INVENTION

The invention relates to adhesives, in particular remoistenable adhesives that may be pre-applied onto a substrate in the foamed state and later reactivated with water to bond the substrate to a second substrate.

### BACKGROUND OF THE INVENTION

Adhesives that may be applied to a substrate and then later reactivated (e.g., by pressure, moisture, and/or heat) to bond the substrate to a second chosen substrate provide a number of advantages. One major advantage is that the end user of the adhesive does not need to devote time and resources to adhesive related issues such as selection, processing, trouble shooting, application, clean-up, inventory and the like.

Water remoistenable adhesives are dry adhesive compositions which, when moistened with water, develop an adhesive tackiness. Water remoistenable pre-applied adhesives are known and practiced in the art. Such adhesives are conventionally used on postage stamps, wallpaper, tapes, labels, envelope flaps and the like. Water remoistenable adhesive compositions are described, for example, in U.S. Pat. Nos. 4,678,824, 4,719,264, 4,910,048 and 5,296,535.

While aqueous liquid adhesives have been used to bond substrate materials, these adhesives have a number of disadvantages associated with their use. Aqueous liquid adhesives require significant drying times and require long set or cure times, and the water contained within them may swell substrate materials (e.g., paper) to which they have been applied. A need exists for alternative methods of preparing articles such as stamps, labels and the like which are safe, effective, improves product quality/appearance, increases process efficiencies and, in addition, provides substantial cost savings. The current invention addresses this need.

### SUMMARY OF THE INVENTION

The current invention provides articles comprising a water remoistenable adhesive which, having been applied to a substrate and allowed to dry, is capable, upon reactivation with moisture, of bonding the substrate to a second substrate.

The invention provides foamed adhesives that may be preapplied to a substrate, in particular a paper substrate, and allowed to dry. When ready to use, i.e., when ready to bond the substrate having the dried adhesive applied thereto to a second substrate, the adhesive is reactivated upon exposure to moisture. The activatable adhesives of the invention may advantageously be used in the preparation of articles, in particular articles such as stamps.

Another aspect of the invention is directed to a process for bonding at least a first paper substrate to at least a second substrate, wherein at least a portion of at least one of said substrates has applied thereon an adhesive which upon exposure to moisture is capable of bonding the substrate to a second substrate. In the practice of the invention a foamed adhesive component is applied to a paper substrate and allowed to dry. The process comprises exposing the applied dry adhesive present on the paper substrate to moisture for a time sufficient to moisten the adhesive, bringing the substrate comprising the remoistened adhesive in contact with another substrate, and allowing the adhesive to dry thereby bonding the paper substrate to the second substrate. Preferably, the second substrate is also a paper substrate.

Still another aspect of the invention is directed to articles of manufacture comprising a water reactivatable adhesive that upon exposure to moisture is capable of bonding a paper substrate to a second substrate. In the practice of the invention a foamed adhesive component is applied to a paper article of manufacture and allowed to dry. Articles include but are not limited to stamps, e.g., postage stamps, stamps used for ordering magazine subscriptions, entering sweepstakes and the like, order forms inserted into bulk commercial mailings such as catalogs and mailers such as return mailers used for film developing, and the like. Articles comprising the dried adhesive, upon rewetting of the adhesive, are capable of being bonded to a second substrate, in particular a second paper substrate.

Yet another aspect of the invention is directed to a method of bonding one substrate to a second substrate, wherein at least one of said first or second substrate has a foamed adhesive preapplied to at least one surface thereof and allowed to dry. The method comprises exposing the adhesive present on the substrate surface to moisture for a time sufficient to remoisten the adhesive, bringing the remoistened adhesive in contact with the substrate to which it is to be bonded and, optionally, applying pressure to effect said bonding together.

### DETAILED DESCRIPTION OF THE INVENTION

In contrast to prior art remoistenable adhesives used in conventional paper and label market, the current invention provides a remoistenable adhesive that was preapplied to the substrate in the foamed state. The adhesive, upon rewetting, has sufficient bonding strength for bonding together substrates made of paper.

The invention relates to a pre-applied adhesive that is activated by remoistening with water and produces a durable bond when contacted with a substrate. The invention is advantageously used to prepare articles of manufacture including but not limited to stamps, e.g., postage stamps, stamps used for ordering magazine subscriptions, entering sweepstakes, ordering musical recordings and the like, order forms inserted into bulk commercial mailings such as catalogs and mailers such as return mailers used for film developing.

The invention encompasses the use of foamed adhesive for the production of stamps, as commonly used for postage, decoration, marketing, promotional and advertising materials and other printed materials. The application involves applying a foamed waterbased adhesive to a paper substrate, drying the adhesive and then passing the substrate comprising the dried adhesive to further processing and handling steps such as cutting an/or perforation.

Adhesives contemplated for use are waterbased and may be comprised of synthetic or natural ingredients. When foamed, such as by mechanical agitation with air, the adhesives form highly stable, consistent foams that can be applied to the substrate.

Water present in adhesives often causes slow drying and can cause the substrate to curl or bend. It has been discovered that the addition of air bubbles to the adhesive can significantly reduce moisture content without affecting adhesive performance even after having been dried and reactivated. Benefits of using a foamed adhesive include improved economics and performance, such as reduced penetration into substrates, reduced moisture and faster set times.

When such paper articles are prepared in accordance with the invention, flatter sheets are produced improving the quality as well as the cutting and perforation (e.g., when manufacturing stamps) processes, adhesive build-up on equipment peripherals (e.g., chill rollers) is substantially reduced or eliminated, dulling of cutting knives and perforators is reduced. In addition, the higher profile of the adhesive coating that results from using a foamed adhesive improves the remoistenablity of the dried adhesive. Particularly advantageous is that manufacture of articles having a foamed adhesive pre-applied thereto leads to significant cost savings.

The application of the adhesive onto a substrate for later activation or “reactivation” is referred to herein, and in the art as a “pre-applied” adhesive. The adhesive present on the substrate may be reactivated at any time after initial application to the substrate for bonding the substrate to a second substrate.

Reactivation, as this term is used herein, refers to an adhesive that resides on at least a portion of at least one substrate to be bonded to a second substrate. That is, the adhesive has been applied to a substrate in the liquid state and allowed to dry, i.e., solidify, thereon. The adhesive present on the first substrate is thereafter reactivated or remoistened back to a liquid state, by contacting the dry adhesive with moisture (e.g., water, mist, steam, saliva or the like). The substrate is brought in contact with the second substrate and the adhesive allowed to dry or solidify, thereby bonding the two substrates together. The terms remoistenable and reactivatable are used interchangeably though out this disclosure.

In the practice of the invention, adhesive present on at least one of the two substrates to be bonded together will be reactivated with water. If adhesive components are present on both substrates to be bonded together, the adhesive components on both substrates will preferably be reactivated with water. The amount of water to be used in the reactivation process will be an amount sufficient to at least partially re-emulsify or resolubilize the adhesive such that it is in a highly softened and tacky state.

The invention encompasses water remoistenable adhesives which, having been applied to a paper substrate, are capable, upon reactivation with moisture, of bonding the paper substrate to a second substrate. Particularly preferred is the use of the reactivated preapplied adhesive to bond one paper substrate to a second paper substrate. When dry, the substrates are held together by a strong durable bond.

Adhesives that can be used in the practice of the invention include synthetic resins, natural resins, natural rubbers, starches or dextrins. The adhesives of the invention may be in the emulsion or solution form. Preferred foamed adhesives comprise at least one resin emulsion, and may also comprise at least one filler or other additive. A preferred resin is polyvinyl acetate. Foamed adhesives comprising a blend of two or more polyvinyl acetate emulsions are contemplated and the use of homopolymers, copolymers and mixtures thereof are encompassed.

Typically, the foamed adhesive comprises more than about 30%, more typically from about 50% by weight to about 100%, more preferably 55% by weight to about 85% by weight of the resin emulsion component and from 0% by weight to about 50% by weight, more typically from about 0% to about 20% by weight of filler and/or other conventional additives.

Resin emulsions that may be used in the practice of the invention are emulsions and mixtures thereof. Adhesives comprising polyvinyl acetate and/or polyvinyl alcohol are preferred for use in the practice of the invention. Mixtures of two or more polyvinyl acetates and mixtures of polyvinyl acetate and other polymer emulsions comprising vinyl acetate and other monomers, including but not limited to ethylene and acrylic monomers, are encompassed. Polyvinyl acetate may be prepared using a continuous or a batch process. Polyvinyl acetate emulsion mixtures wherein the polyvinyl acetates used are prepared by one method or by both methods may be used. Such polyvinyl acetates are commercially available from National Starch and Chemical, Bridgewater, N.J.

The adhesive may also contain a filler or other conventional ingredients. The addition of a filler allows for foam generated to remain consistent and stable for several hours. Suitable fillers are those fillers known in the art as adhesive fillers and include polysaccharides, calcium carbonate, clay, mica, nut shell flours, silica, talc and wood flour.

Polysaccharides useful in the invention include starch, dextrin, cellulose, gums or combinations thereof. Particularly useful are the starches and dextrins including native, converted or derivatized. Such starches include those derived from any plant source including maize (corn), potato, wheat, rice, sago, tapioca, waxy maize, sorghum and high amylose starch such as high amylose corn, i.e. starch having at least 45% amylose content by weight. Starch flours may also be used. Also included are the conversion products derived from any of the former bases, such as, for example, dextrins prepared by hydrolytic action of acid and/or heat; fluidity or thin boiling starches prepared by enzyme conversion or mild acid hydrolysis; oxidized starches prepared by treatment with oxidants such as sodium hypochlorite; and derivatized or modified starches such as cationic, anionic, amphoteric, non-ionic, crosslinked and hydroxypropyl starches. Other useful polysaccharides are cellulose materials such as carboxymethylcellulose, hydroxypropyl cellulose and hydroxypropyl methylcellulose, and gums such as guar, xanthan, pectin and carrageenan may also be used in the practice of the invention. Modified starches include, but are not limited to, those modified with an alkyl succinic anhydride. Preferred are octenyl succinic anhydride (OSA) and dodecenyl succinic anhydride (DDSA) modified starches or dextrins.

The adhesive may also preferably contain a surface-active agent. Examples of surface-active agents include anionic, cationic, amphoteric, or nonionic surfactants, or mixtures thereof. Suitable anionic surfactants include, alkyl sulfonates, alkylaryl sulfonates, alkyl sulfates, sulfates of hydroxylalkanols, alkyl and alkylaryl disulfonates, sulfonated fatty acids, sulfates and phosphates of polyethoxylated alkanols and alkylphenols, and esters of sulfosuccinic acid. Suitable cationic surfactants include, alkyl quaternary ammonium salts, and alkyl quaternary phosphonium salts. Suitable non-ionic surfactants include the addition products of 5 to 50 moles of ethylene oxide adducted to straight-chain and branched-chain alkanols having 6 to 22 carbon atoms, alkylphenols, higher fatty acids, higher fatty acid amines, primary or secondary higher alkyl amines, and block copolymers of propylene oxide with ethylene oxide, and mixtures thereof. Suitable amphoteric surfactants include disodium lauramino propionate. Surfactants useful in the practice of the invention include surfactants modified with, e.g., alkyl succinic anhydrides, such as OSA. When used, the surface active agent will typically be added in amounts up to about 20% by weight, based on the foamable composition as a whole. More usually from amounts of from about 0.05 to about 20% by weight, and preferably at from 0.1 to 2% by weight.

Other additives typical of adhesive compositions may be added to the foamable composition of the invention. Said additives include, but are not limited to, humectants, flavorants, crosslinkers, plasticizers, acids, waxes, synthetic resins, tackifiers, defoamers, preservatives, bases such as sodium hydroxide, dyes, pigments, UV indicators, and other additives commonly used in the art.

Examples of humectants include those conventionally used in aqueous adhesives such as sugars (sucrose, fructose), urea, glycols, glycerine and salts such as sodium chloride, sodium nitrate and calcium chloride. The humectant will generally be used in amounts of from about 1.0 to about 20.0%.

Typical preservatives for use herein include those conventionally used in aqueous adhesives such as benzoates, amides and fluorides such as sodium fluoride. Also included are the hydroxybenzoic acid esters such as p-hydroxybenzoic acid methyl ester or p-hydroxybenzoic butyl ester. Commercially available preservatives which may be used in the practice of the invention include KATHON LXE sold by Rohm & Haas Company and Nipacide OBS sold by Clariant. The preservative will generally be included in amounts of from 0.05% to about 0.2% by weight.

The foamable adhesive composition of the invention is foamed by the addition of energy, by means known in the art such as, but not limited to, by mechanical and/or chemical means. Air or other gases are added to the foamable adhesive composition along with the addition of said energy to produce a stable, consistent foamed adhesive. Preferably air is used to produce the foamed adhesive. The adhesive foam may be produced by mechanical means such as mechanical stirring or agitation, introduction of gases or by chemical means.

The amount of air dispersed in the adhesive can vary depending on the particular formulation, but will generally be from about 5% (by volume) up to about 75% (by volume) or greater, more typically from about 10 up to about 50% (by volume), even more typically from about 20 up to about 35% (by volume).

The adhesive may be applied by any method known in the art. The adhesive product can be applied to a substrate by a variety of methods including coating or spraying in an amount sufficient to cause the article to adhere to another substrate upon reactivation. The foamed adhesive formulations of the invention may be pre-applied in a continuous or discontinuous, e.g., as evenly spaced beads or dots, manner depending on surface area and coating weight desired. Particular coating patterns and thickness may be chosen to optimize substrate/adhesive contact. The adhesive may be pre-applied to the substrate by any method known in the art, and include, without limitation slot-coating, swirl spraying, extrusion, contact extrusion, atomized spraying, smooth roll, grooved roll, stencil, gravure (pattern wheel transfer), screen printing. Roller and stencil applicators are particularly preferred for use in applying the adhesive a paper substrate such as in the manufacture of remoistenable stamps. Typically the substrate material is coated with from about 3 to about 4 wet mils of foamed adhesive.

The method of pre-application of the adhesive to the substrate is not critical to the practice of the invention. The adhesive is applied to a substrate while in its liquid state and allowed to dry to harden the adhesive layer. The adhesive can be allowed to air dry or can be dried by other conventional means, such as with the use of ovens.

The reactivation efficiency, i.e., the ability of the adhesive to become wetted or moistened in a short period of time will depend on the water solubility of the components in the adhesive formulation. Reactivation time depends on receptivity of the adhesive, which depends on the coating weight or thickness of the adhesive and the amount of water applied.

In the practice of the invention, exposure to moisture is typically for periods of less than about 5 seconds. Pressure is typically applied for periods of less than about 30 seconds. Typically water is used to wet the surfaces. The water may be in the form of a mist, spray, saturated material (e.g., wet sponge) or steam. Saliva (i.e., licking the adhesive with the tongue) will typically be used by the consumer to activate the adhesive present on stamps, mailers and the like.

The adhesive formulations of the invention may be used to bond one substrate to a second similar or different substrate. Preferred are paper substrates. Use of the term “paper” is meant to include light paper, paperboard, cardboard, corrugated paperboard, polyolefin coated paper and the like. The surface of the paper to which the adhesive is applied may be printed or be unprinted.

The adhesive of the invention may be applied to various articles of manufacture and can advantageously be used to bond substrates together. The invention provides a process of bonding a first substrate to a second substrate wherein said first substrate has preapplied to at least a portion of a surface of said first substrate a first adhesive composition and wherein said second substrate has preapplied to at least a portion of a surface of said second substrate a second adhesive composition, said method comprising contacting said first adhesive present on said first substrate to said second adhesive present on said second substrate thereby bonding said first substrate to the second substrate. In one embodiment the preapplied adhesive on at least one of said first or second substrate is activated by exposure to moisture prior to contacting said first adhesive to said second adhesive.

The invention provides a water remoistenable adhesive which, having been applied to a paper substrate and allowed to dry, is capable, upon reactivation with moisture, of bonding the paper substrate to a second substrate. Adhesives useful in the practice of the invention will generally exhibit greater than 50% fiber tear, more typically greater than 75% fiber tear, even more preferred for use are adhesives exhibiting complete substrate failure (100% fiber tear).

The invention is further illustrated by the following non-limiting example.

### EXAMPLE

An adhesive comprising 57 parts polyvinylacetate homopolymer, 8.5 parts polyvinylalcohol, 3.5 parts humectant, 0.1 parts preservative and 0.1 parts surfactant and 30.8 parts water was prepared and foamed to 28%. The foamed adhesive had a viscosity of 1,200 centipoise, a solids content of 44%, and pH of 5.5. The foamed adhesive was used to coat the surface of a 3 mil paper substrate and allowed to air dry completely. The substrate that had been pre-applied with adhesive was rewetted and bonds prepared immediately following rewetting by bringing wetted adhesive present on the substrate in contact with a second substrate. The welded substrates were allowed to set for one hour at room temperature. Bond strength and % fiber test was tested. 100% fiber tear was observed.

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

1. A water remoistenable adhesive applied to a paper substrate in the foamed state and allowed to dry, wherein the adhesive is capable, upon reactivation with moisture, of bonding the paper substrate to a second substrate.

2. The adhesive of claim 1 comprising a polyvinyl acetate polymer or copolymer.

3. The adhesive of claim 1 comprising a water soluble polymer.

4. The adhesive of claim 3 wherein the water soluble polymer is a polyvinyl alcohol.

5. The adhesive of claim 1 wherein the adhesive was foamed by mechanical and/or chemical means.

6. A method of bonding a first substrate to a second substrate wherein said first and/or second substrate has preapplied to at least a portion of a surface of said first and/or second substrate a water remoistenable foamed adhesive, said method comprising contacting the adhesive present on said first and/or second substrate with moisture to reactivate the adhesive and thereafter bring the surfaces of said first substrate and second substrates together whereby the first substrate is bonded to the second substrate.

7. An article of manufacture having applied to at least one surface thereof the foamed adhesive of claim 1.

8. The article of claim 7 which is a stamp.
